(19) United States
(12) Patent Application Publication
(10) Pub. No.: US 2013/0208734 A1
(43) Pub. Date: Aug. 15, 2013

(54) SYSTEMS AND METHODS FOR COMMUNICATING AGGREGATED PACKETS INCLUDING DELIMITERS

(71) Applicant: QUALCOMM Incorporated, (US)

(72) Inventors: Maarten Menzo Wentink, Breukelen (NL); Didier Johannes Richard Van Nee, De Meern (NL)

(73) Assignee: QUALCOMM Incorporated, San Diego, CA (US)

(21) Appl. No.: 13/737,780

(22) Filed: Jan. 9, 2013

Related U.S. Application Data
(60) Provisional application No. 61/597,951, filed on Feb. 13, 2012.

(51) Int. Cl. H04W 28/06

(52) U.S. Cl. CPC H04W 28/065
USPC 370/474

(57) ABSTRACT

Systems, methods, and computer program products for communicating aggregated packets including delimiters are described herein. In one aspect, a processor is configured to prepare a packet comprising an aggregated media access control service data unit (A-MSDU) having a plurality of MSDU subframes. Each MSDU subframe includes a MSDU subframe header and a MSDU. Further, the processor is configured to insert an indication of an end of the A-MSDU in the A-MSDU. A transmitter is configured to transmit the packet wirelessly. In another aspect, a receiver is configured to receive wirelessly a packet comprising an A-MSDU having a plurality of MSDU subframes and an indication of an end of the A-MSDU in the A-MSDU. A processor is configured to determine the end of the A-MSDU based on the indication.

### CLAIM OF PRIORITY UNDER 35 U.S.C. §119

The present Application for Patent claims priority to Provisional Application No. 61/597,951 entitled “SYSTEMS AND METHODS FOR COMMUNICATING AGGREGATED PACKETS INCLUDING DELIMITERS” filed Feb. 13, 2012, and assigned to the assignee hereof and hereby expressly incorporated by reference herein.

### FIELD

The present application relates generally to wireless communications, and more specifically to systems, methods, and devices for communicating aggregated packets including delimiters.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit or receive information between each other. The information may take the form of aggregated packets transmitted from a source device (the transmitting device) to a destination device (the receiving device). Accordingly, improved systems, methods, and devices for communication of such aggregated packets are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include reducing the amount of information carried in a PHY header of an aggregated media access control protocol data unit (A-MPDU).

One aspect of this disclosure is an apparatus for wireless communication comprising a processor configured to prepare a packet comprising an aggregated media access control service data unit (A-MSDU) having a plurality of MSDU subframes and to insert an indication of an end of the A-MSDU in the A-MSDU, each MSDU subframe comprising a MSDU subframe header and a MSDU; and a transmitter configured to transmit the packet wirelessly.

Another aspect of this disclose is an apparatus for wireless communication comprising a receiver configured to receive wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and a processor configured to determine the end of the A-MSDU based on the indication.

One aspect of this disclosure is a method for wireless communication comprising preparing a packet comprising an aggregated media access control service data unit (A-MSDU) having a plurality of MSDU subframes, each MSDU subframe comprising a MSDU subframe header and a MSDU; inserting an indication of an end of the A-MSDU in the A-MSDU; and transmitting the packet wirelessly.

Another aspect of this disclosure is a method for wireless communication comprising receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and determining the end of the A-MSDU based on the indication.

One aspect of this disclosure is an apparatus for wireless communication comprising means for preparing a packet comprising an aggregated media access control service data unit (A-MSDU) having a plurality of MSDU subframes, each MSDU subframe comprising a MSDU subframe header and a MSDU; means for inserting an indication of an end of the A-MSDU in the A-MSDU; and means for transmitting the packet wirelessly.

Another aspect of this disclosure is an apparatus for wireless communication comprising means for receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and means for determining the end of the A-MSDU based on the indication.

One aspect of this disclosure is a non-transitory computer storage that stores executable program instructions that direct an apparatus to perform a process that comprises preparing a packet comprising an aggregated media access control service data unit (A-MSDU) having a plurality of MSDU subframes, each MSDU subframe comprising a MSDU subframe header and a MSDU; inserting an indication of an end of the A-MSDU in the A-MSDU; and transmitting the packet wirelessly.

Another aspect of this disclosure is a non-transitory computer storage that stores executable program instructions that direct an apparatus to perform a process that comprises receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and determining the end of the A-MSDU based on the indication.

### BRIEF DESCRIPTION OF THE DRAWINGS

FIG. 1 shows an example wireless communication system in which aspects of the present disclosure may be employed.

FIG. 2 shows a functional block diagram of an example wireless device that may be employed within the wireless communication system of FIG. 1.

FIG. 3A illustrates an example aggregated media access control service data unit (A-MSDU) with long MSDU subframe format.

FIG. 3B illustrates an example A-MSDU with short MSDU subframe format.

FIG. 4A illustrates an example PLCP protocol data unit (PPDU) including an aggregated MAC protocol data unit (A-MPDU).

FIG. 4B illustrates an example PPDU including an A-MPDU.

FIG. 5A illustrates an example A-MSDU with long MSDU subframe format.

FIG. 5B illustrates an example A-MSDU with short MSDU subframe format.

FIG. 6A illustrates an example A-MSDU with long MSDU subframe format.

FIG. 6B illustrates an example A-MSDU with short MSDU subframe format.

FIG. 7A illustrates an example PPDU including a MPDU.

FIG. 7B illustrates an example PPDU including an A-MPDU.

FIG. 8A illustrates an example PPDU including a MPDU.

FIG. 8B illustrates an example PPDU including two MPDUs.

FIG. 9A illustrates an example PPDU including an A-MPDU and a MSDU.

FIG. 9B illustrates an example PPDU including an A-MPDU and two MSDUs.

FIG. 9C illustrates an example PPDU including an A-MPDU and an A-MSDU.

FIG. 10 illustrates an example MSDU subframe header.

FIG. 11 is a flow chart of an example method of communicating aggregated packets including delimiters.

FIG. 12 is a functional block diagram of an example wireless communication device that may be employed in the wireless communication system of FIG. 1.

FIG. 13 is a flow chart of an example method of communicating aggregated packets including delimiters.

FIG. 14 is a functional block diagram of an example wireless communication device that may be employed in the wireless communication system of FIG. 1.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Popular wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11 ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

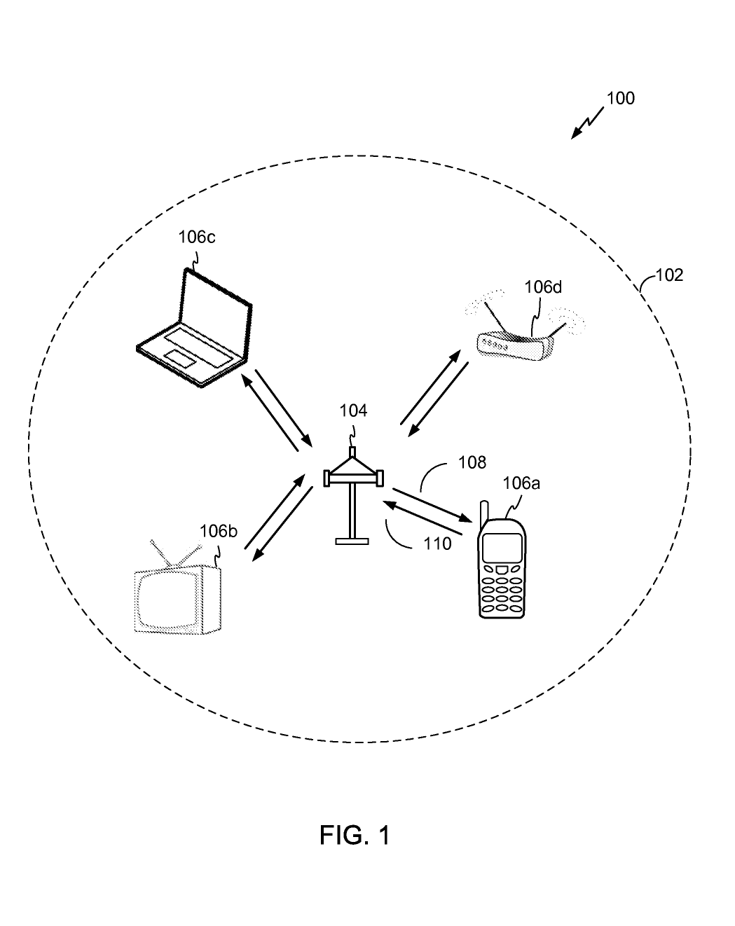

FIG. 1 shows an example wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

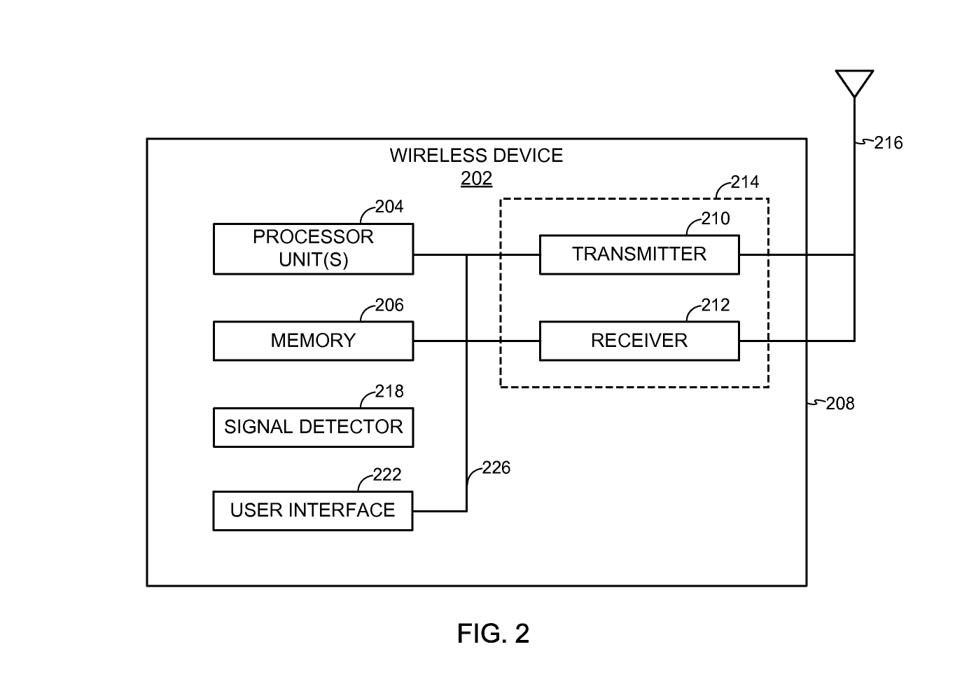

FIG. 2 shows an example functional block diagram of a wireless device 202 that may be employed within the wireless communication system 100 of FIG. 1. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The transmitter 210 may be configured to wirelessly transmit packets, which may include header and payload information as discussed below. For example, the transmitter 210 may be configured to transmit packets generated by the processor 204, discussed above.

The receiver 212 may be configured to wirelessly receive packets.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

For ease of reference, when the wireless device 202 is configured as a transmitting node, it is hereinafter referred to as a wireless device 202t. Similarly, when the wireless device 202 is configured as a receiving node, it is hereinafter referred to as a wireless device 202r. A device in the wireless communication system 100 may implement only functionality of a transmitting node, only functionality of a receiving node, or functionality of both a transmitting node and a receive node.

As discussed above, the wireless device 202 may comprise an AP 104 or an STA 106, and may be used to transmit and/or receive data.

Described herein are systems, methods, and devices for communicating aggregated packets including delimiters, such as from the wireless device 202t, to a destination device, such as the wireless device 202r. Certain aspects are described herein with respect to media access control (MAC) headers and payloads. However, the aspects described are not limited to MAC headers and can equally be applied to other appropriate types of headers and packets. Additionally, in this disclosure, paddings may be omitted from figures and descriptions of packets for clarity or to emphasize aspects of the disclosure.

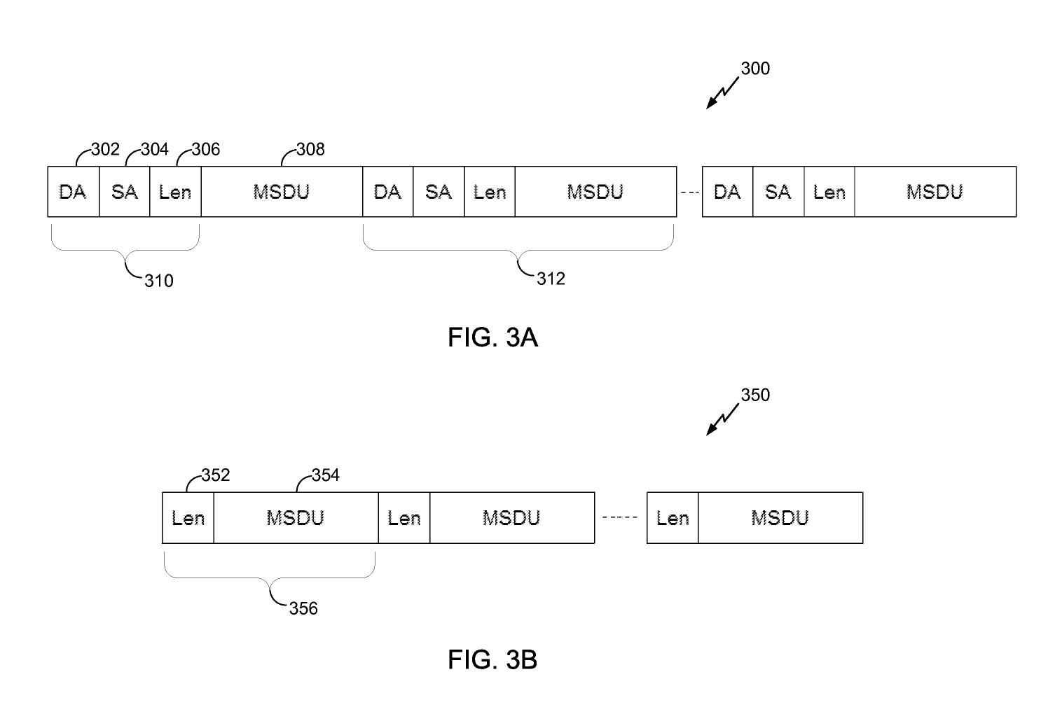

FIG. 3A illustrates an example aggregated MAC service data unit (A-MSDU) 300 with long MSDU subframe format. The A-MSDU includes one or more consecutive long MSDU subframes, such as the MSDU subframe 312. Each of the one or more long MSDU subframes may comprise a long MSDU subframe header, such as the MSDU subframe header 310, and a MSDU, such as the MSDU 308. The long MSDU subframe header, such as the MSDU subframe header 310, may comprise a destination address (DA) field 302, a source address (SA) field 304, and a length (Len) field 306.

FIG. 3B illustrates an example A-MSDU 350 with short MSDU subframe format. The A-MSDU 350 includes one or more consecutive short MSDU subframes, such as the MSDU subframe 356. Each of the one or more short MSDU subframes may comprise a short MSDU subframe header, such as the length (Len) field 352, and a MSDU, such as the MSDU 354. The A-MSDU 350 of FIG. 3B may be used instead of the A-MSDU 300 of FIG. 3A when the destination address and source address may be the same across aggregated MSDUs.

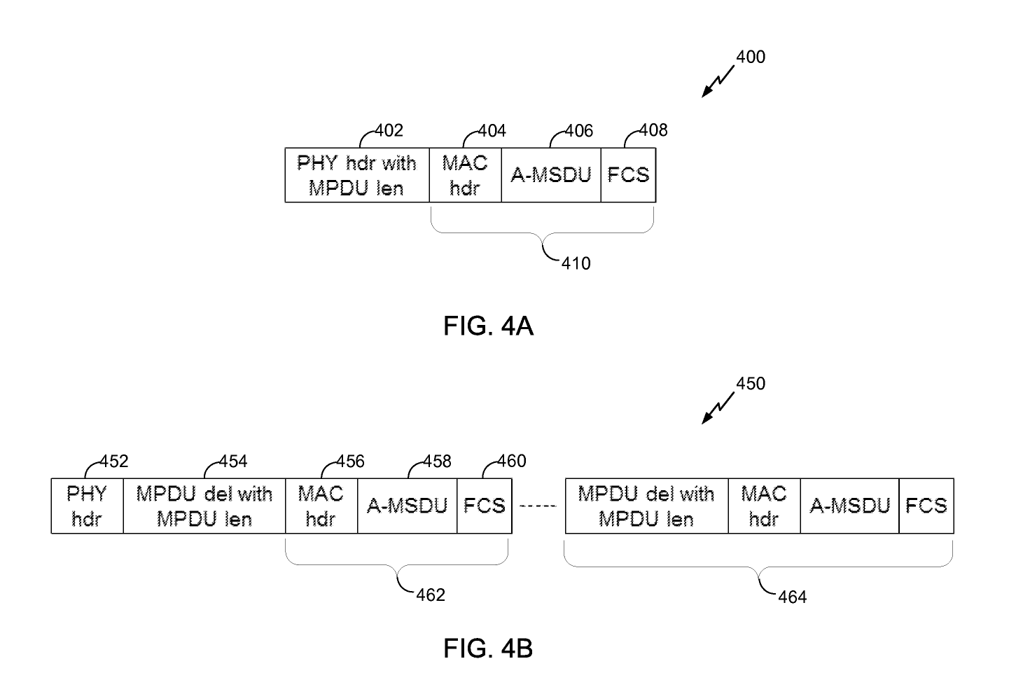

FIG. 4A illustrates an example PLCP protocol data unit (PPDU) 400. The PPDU 400 may include a PHY header (hdr) 402 and a media access control protocol data unit (MPDU) 410. The PHY header 402 may be configured to indicate a length of the MPDU 410. The MPDU 410 may include a MAC header 404, an A-MSDU 406, and a frame check sequence (FCS) field 408.

FIG. 4B illustrates an example PPDU 450. The PPDU 450 may include a PHY header 452 and one or more consecutive MPDU subframes, such as the MPDU subframe 464. Each of the one or more MPDU subframes may comprise a MPDU delimiter, such as the MPDU delimiter 454, and a MPDU, such as the MPDU 462. The MPDU delimiter of one MPDU subframe may be configured to indicate a length of the MPDU of the same one MPDU subframe. Each MPDU, such as the MPDU 462, may comprise a MAC header (hdr) 456, an A-MSDU 458, and a frame check sequence (FCS) field 460.

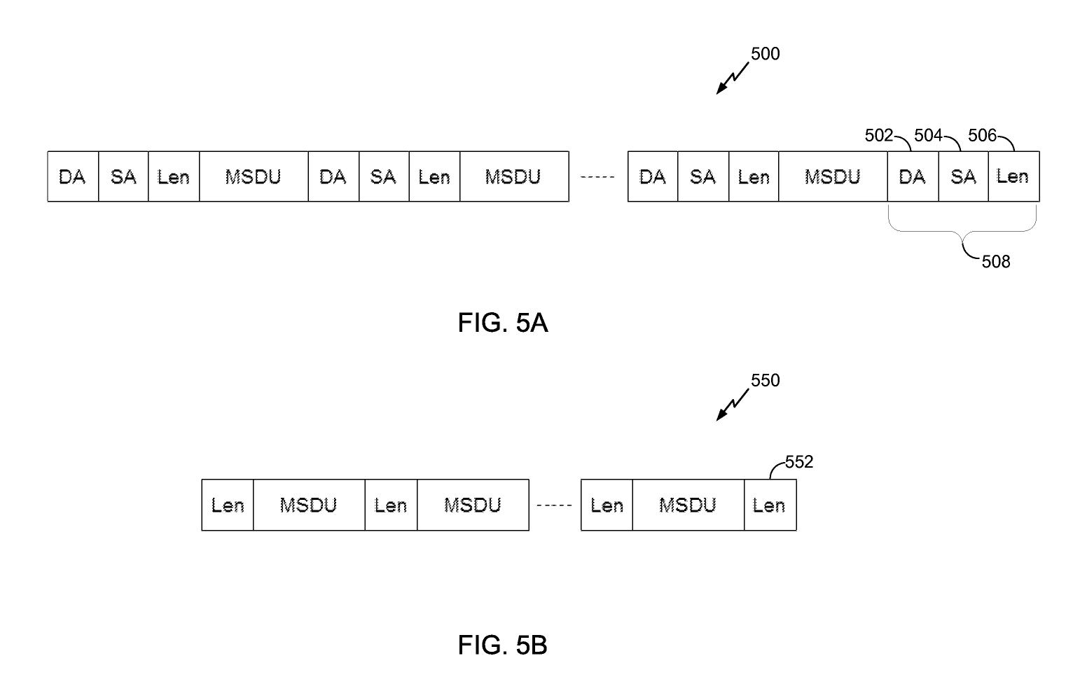

FIG. 5A illustrates an example A-MSDU 500 with long MSDU subframe format. The A-MSDU 500 of FIG. 5A may similar to the A-MSDU 300 of FIG. 3A except that an indicator MSDU subframe header 508 has been inserted after the final MSDU subframe of the one or more MSDU subframes. The indicator MSDU subframe header 508 may be configured to indicate an end of the A-MSDU 500.

The indicator MSDU subframe header 508 may include a destination address (DA) field 502, a source address (SA) field 504, and a length (Len) field 506. In some aspects, the length field 506 may be configured to indicate the end of the A-MSDU 500. For example, when a value contained in the length field 506 equals 0, the indication may be that the end of the A-MSDU 500 has been reached and no further MSDU subframes will follow. The destination address field 502 and source address field 504 may then be set to values based on other considerations. In some aspects, the destination address field 502 may be configured to indicate the end of the A-MSDU 500. For example, when a value contained in the destination address field 502 equals a particular address, the indication may be that the end of the A-MSDU 500 has been reached and no further MSDU subframes will follow. In such a case, the source address field 504 and length field 506 may be omitted.

FIG. 5B illustrates an example A-MSDU 550 with short MSDU subframe format. The A-MSDU 550 of FIG. 5B may similar to the A-MSDU 350 of FIG. 3B except that an indicator MSDU subframe header 552 has been inserted after the final MSDU subframe of the one or more MSDU subframes. The indicator MSDU subframe header 552 may be configured to indicate an end of the A-MSDU 550.

The indicator MSDU subframe header 552 may include a length (Len) field 552. The length field 552 may be configured to indicate the end of the A-MSDU 550. For example, when a value contained in the length field 552 equals 0, the indication may be that the end of the A-MSDU 550 has been reached and no further MSDU subframes will follow.

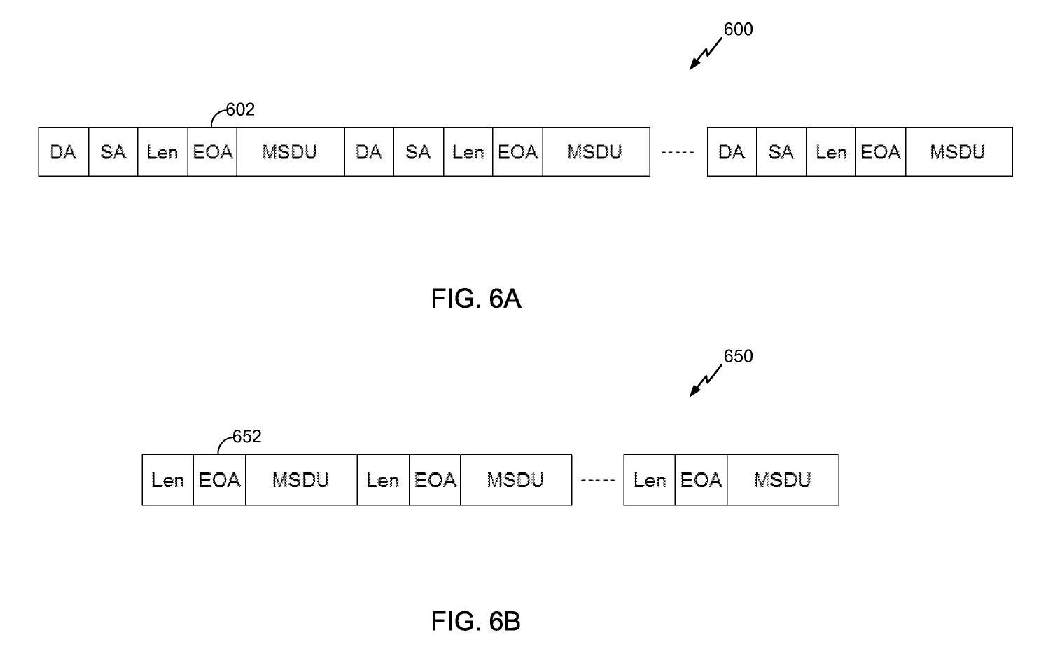

FIG. 6A illustrates an example A-MSDU 600 with long MSDU subframe format. The A-MSDU 600 of FIG. 6A may similar to the A-MSDU 300 of FIG. 3A except that an indicator field may be inserted in the MSDU subframe header of one or more MSDU subframes. In some aspects, the EOA field may be included all MSDU subframe headers. In other aspects, the EOA field may be included in some MSDU subframe headers while not in other MSDU subframe headers.

The indicator field may include an end of A-MSDU (EOA) field, such as EOA field 602. A value contained in the EAO field may be configured to indicate an end of the A-MSDU 600 or a final MSDU subframe of the one or more MSDU subframes. For example, when a value contained in a 1-bit length EOA field equals 0, the indication may be that the final MSDU subframe of the one or more MSDU subframes has been reached. The final MSDU subframe may indicate that an end of the A-MSDU 600 has been reached and no further MSDU subframes will follow. In some aspects, the EOA field may be known as the “more MSDU” field.

FIG. 6B illustrates an example A-MSDU with short MSDU subframe format. The A-MSDU 650 of FIG. 6B may similar to the A-MSDU 350 of FIG. 3B except that an indicator field may be inserted in the MSDU subframe header of one or more MSDU subframes. In some aspects, the EOA field may be included all MSDU subframe headers. In other aspects, the EOA field may be included in some MSDU subframe headers while not in other MSDU subframe headers.

The indicator field may include an end of A-MSDU (EOA) field, such as EOA field 652. A value contained in the EAO field may be configured to indicate an end of the A-MSDU 650 or a final MSDU subframe of the one or more MSDU subframes. For example, when a value contained in a 1-bit length EOA field equals 0, the indication may be that the final MSDU subframe of the one or more MSDU subframes has been reached. The final MSDU subframe may indicate that an end of the A-MSDU 650 has been reached and no further MSDUs will follow.

In some aspects, the indication approaches discussed in the descriptions of FIGS. 5A, 5B, 6A, and 6B may be used for some packets and not used other packets. Further, one indication approach, such as the approach of FIG. 5A, may be used for some packets and another indication approach, such as the approach of FIG. 6A, may be used for other packets. Advantageously, the indication approaches discussed in the descriptions of FIGS. 5A and 5B may be used when the number of MSDU subframes is large relative to the size of the length field. The approaches of FIGS. 5A and 5B may then be more efficient. Advantageously, the indication approaches discussed in the descriptions of FIGS. 6A and 6B may be used when the number of MSDU subframes is small relative to the size of the length field. The approaches of FIGS. 6A and 6B may then be more efficient.

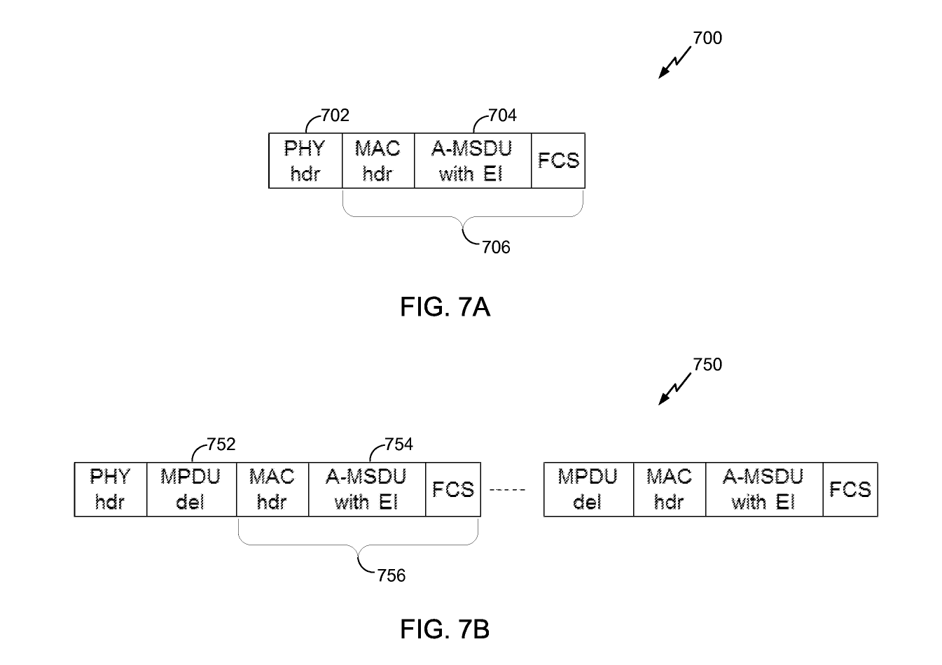

FIG. 7A illustrates an example PPDU 700. The PPDU 700 of FIG. 7A may similar to the PPDU 400 of FIG. 4A except that the PHY header 702 may not configured to indicate a length of the MPDU 706 and that the A-MSDU with end indication (EI) 704 may be configured to indicate an end of the A-MSDU 704.

Accordingly, advantageously, the PHY header 702 may carry a duration in units of symbols and may not need to include a length field to store the length of the MPDU 706 (e.g., a number of octets of the MPDU 706). The length of the MPDU 706 may be inferred from an end of the A-MSDU 704.

FIG. 7B illustrates an example PPDU 750. The PPDU 750 of FIG. 7B may similar to the PPDU 450 of FIG. 4B except that the MPDU delimiter 752 may not be configured to indicate a length of the MPDU 756 and that the A-MSDU with end indication (EI) 754 may be configured to indicate an end of the A-MSDU 754.

The MPDU delimiter 752 may include a cyclical redundancy check (CRC) field and a delimiter signature field. The cyclical redundancy check field may, in some aspects, contain a value indicative of the length of the MPDU 756. Accordingly, advantageously, since the cyclical redundancy check field of the MPDU delimiter 752 may not need to store the length of the MPDU 756, the cyclical redundancy check field may be omitted in some aspects and the length of the MPDU 756 may be inferred from an end of the A-MSDU 754.

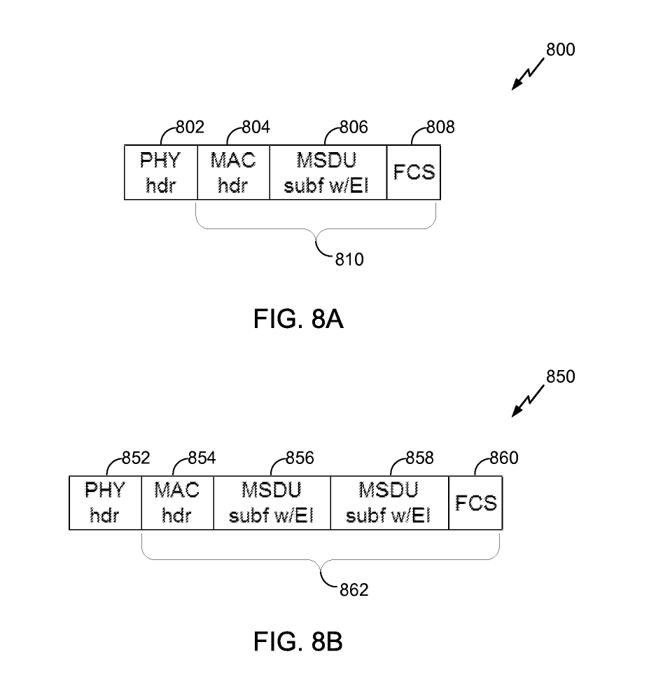

FIG. 8A illustrates an example PPDU 800. As illustrated, the PPDU 800 includes a MPDU 810 and a MSDU. More specifically, the PPDU 800 may include a PHY header (hdr) 802, a MAC header 804, a MSDU subframe with end indication (EI) 806, and a frame check sequence (FCS) field 808. In this example, because the PPDU 800 does not include an A-MPDU, an MSDU subframe may be used in place of the MSDU to indicate the length of the MSDU.

The PHY header 802 may include a PPDU length in symbols and an indication of whether the packet includes an A-MPDU or a MPDU (e.g., if an aggregation field of the PHY header 802 contains the value 0, the PPDU 800 includes a MPDU). However, the PHY header 802 may not include an indication of a length in octets of the MPDU 810. The MAC header 804 may include an indication of whether the following one or more fields include MSDU subframes or an MSDU (e.g., if an A-MSDU field of the MAC header 804 contains the value 1, the following one or more fields include MSDU subframes).

Further, the MSDU subframe 806 may include in the MSDU subframe header an indication of the length of the MSDU subframe 806 (e.g., number of octets of the MSDU) and whether additional MSDU subframes follow (e.g., if a more MSDU field contains the value 0, no additional MSDU subframes follow).

FIG. 8B illustrates an example PPDU 850. As illustrated, the PPDU 850 includes a MPDU 862 and two MSDUs. More specifically, the PPDU 850 includes a PHY header (hdr) 852, a MAC header 854, a first MSDU subframe with end indication (EI) 856, a second MSDU subframe with end indication 858, and a frame check sequence (FCS) field 860. In this example, because the PPDU 850 does not include an A-MPDU, MSDU subframes may be used in place of the MSDUs to indicate the length of the MSDUs.

The PHY header 852 may include a PPDU length in symbols and an indication of whether the PPDU 850 includes an A-MPDU or a MPDU (e.g., if an aggregation field of the PHY header 852 contains the value 0, the PPDU 850 includes a MPDU). However, the PHY header 852 may not include an indication of a length in octets of the MPDU 862. The MAC header 854 may include an indication of whether the following one or more fields include MSDU subframes or an MSDU (e.g., if an A-MSDU field of the MAC header 854 contains the value 1, the following one or more fields include MSDU subframes).

The first MSDU subframe 856 may include in the first MSDU subframe header an indication of the length of the first MSDU subframe 856 (e.g., number of octets of the first MSDU) and whether an additional MSDU subframe follows (e.g., if a more MSDU field of the first MSDU subframe header contains the value 1, an additional MSDU subframe follows). Similarly, the second MSDU subframe 858 may include in the second MSDU subframe header an indication of the length of the second MSDU subframe 858 (e.g., number of octets of the second MSDU) and whether an additional MSDU subframe follows (e.g., if a more MSDU field of the second MSDU subframe header contains the value 0, no additional MSDU subframes follow).

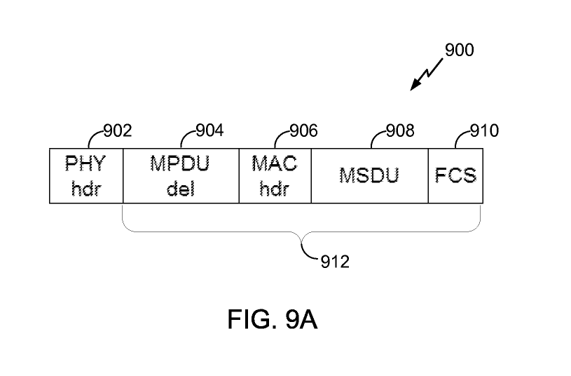

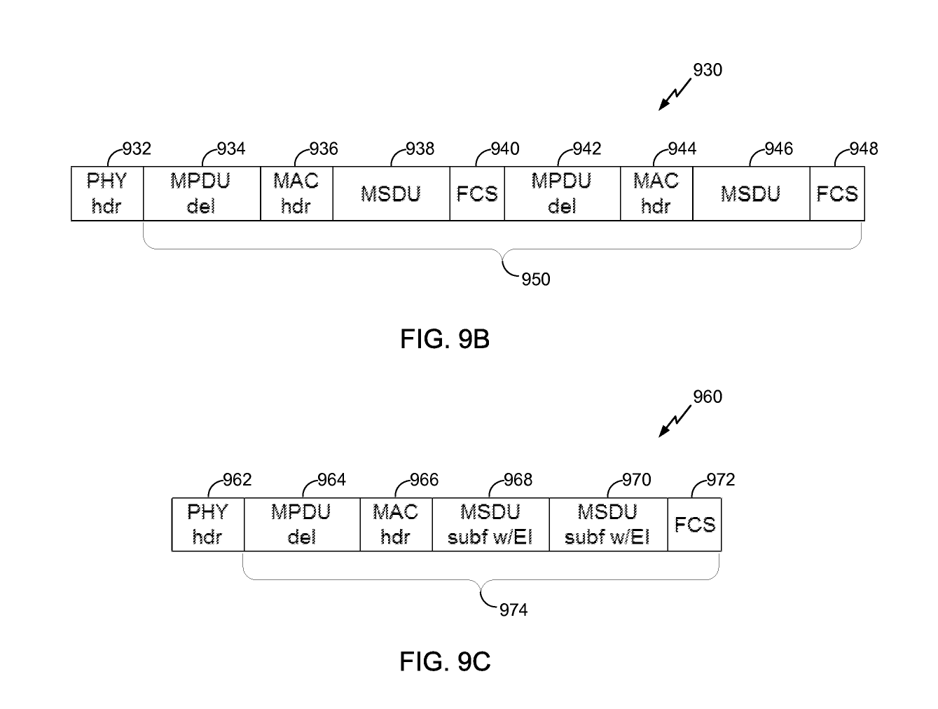

FIG. 9A illustrates an example PPDU 900. As illustrated, the PPDU 900 includes an A-MPDU 912 and a MSDU 908. More specifically, the PPDU 900 includes a PHY header (hdr) 902, a MPDU delimiter 904, a MAC header 906, a MSDU 908, and a frame check sequence (FCS) field 910. In this example, because the PPDU 900 does include an A-MPDU, an MSDU subframe may not need to be used in place of the MSDU to indicate the length of the MSDU.

The PHY header 902 may include a PPDU length in symbols and an indication of whether the PPDU 900 includes an A-MPDU or a MPDU (e.g., if an aggregation field of the PHY header 902 contains the value 1, the PPDU 900 includes an A-MPDU). However, the PHY header 902 may not include an indication of a length in octets of the A-MPDU 912.

The MPDU delimiter 904 may include a delimiter signature field and a cyclical redundancy check field, as well as an indication of the length of the A-MPDU 912 (e.g., number of octets of the A-MPDU 912). The MAC header 906 may include an indication of whether the following one or more fields include MSDU subframes or an MSDU (e.g., if an A-MSDU field of the MAC header 906 contains the value 0, the following field includes a MSDU).

FIG. 9B illustrates an example PPDU 930. As illustrated, the PPDU 930 includes an A-MPDU 950 with two MPDU subframes, each MPDU subframe including a MSDU. More specifically, the PPDU 930 includes a PHY header (hdr) 932, a first MPDU delimiter 934, a first MAC header 936, a first MSDU 938, a first frame check sequence (FCS) field 940, a second MPDU delimiter 942, a second MAC header 944, a second MSDU 946, and a second frame check sequence field 948. In this example, because the PPDU 930 does include an A-MPDU, MSDU subframes may not need to be used in place of the MSDUs to indicate the length of the MSDUs.

The PHY header 932 may include a PPDU length in symbols and an indication of whether the PPDU 930 includes an A-MPDU or a MPDU (e.g., if an aggregation field of the PHY header 932 contains the value 1, the PPDU 930 includes an A-MPDU). However, the PHY header 932 may not include an indication of a length in octets of the A-MPDU 950.

The first MPDU delimiter 934 may include a first delimiter signature field and a first cyclical redundancy check field, as well as an indication of the length of the first MPDU subframe (e.g., number of octets of the first MPDU). The first MAC header 936 may include an indication of whether the following one or more fields include MSDU subframes or an MSDU (e.g., if an A-MSDU field of the first MAC header 936 contains the value 0, the following field includes a MSDU).

Similarly, the second MPDU delimiter 942 may include a second delimiter signature field and a second cyclical redundancy check field, as well as an indication of the length of the second MPDU subframe (e.g., number of octets of the second MPDU). The second MAC header 944 may include an indication of whether the following one or more fields include MSDU subframes or an MSDU (e.g., if an A-MSDU field of the second MAC header 944 contains the value 0, the following field includes a MSDU).

FIG. 9C illustrates an example PPDU 960. As illustrated, the PPDU 960 includes an A-MPDU 974 and an A-MSDU, the A-MSDU including two MSDU subframes. More specifically, the PPDU 960 includes a PHY header (hdr) 962, a MPDU delimiter 964, a MAC header 966, a first MSDU subframe with end indication (EI) 968, a second MSDU subframe with end indication 970, and a frame check sequence (FCS) field 972.

The PHY header 962 may include a PPDU length in symbols and an indication of whether the PPDU 960 includes an A-MPDU or a MPDU (e.g., if an aggregation field of the PHY header 962 contains the value 1, the PPDU 960 includes an A-MPDU). However, the PHY header 962 may not include an indication of a length in octets of the A-MPDU 974.

The MPDU delimiter 964 may include a delimiter signature field and a cyclical redundancy check field, as well as an indication of the length of the A-MPDU (e.g., number of octets of the MPDU). The MAC header 966 may include an indication of whether the following one or more fields include MSDU subframes or an MSDU (e.g., if an A-MSDU field of the MAC header 966 contains the value 1, the following one or more fields include MSDU subframes).

The first MSDU subframe 968 may include in the first MSDU subframe header an indication of the length of the first MSDU subframe 968 (e.g., number of octets of the first MSDU) and whether an additional MSDU subframe follows (e.g., if a more MSDU field of the first MSDU subframe header contains the value 1, an additional MSDU subframe follows). Similarly, the second MSDU subframe 970 may include in the second MSDU subframe header an indication of the length of the second MSDU subframe 970 (e.g., number of octets of the second MSDU) and whether an additional MSDU subframe follows (e.g., if a more MSDU field of the second MSDU subframe header contains the value 0, no additional MSDU subframes follow).

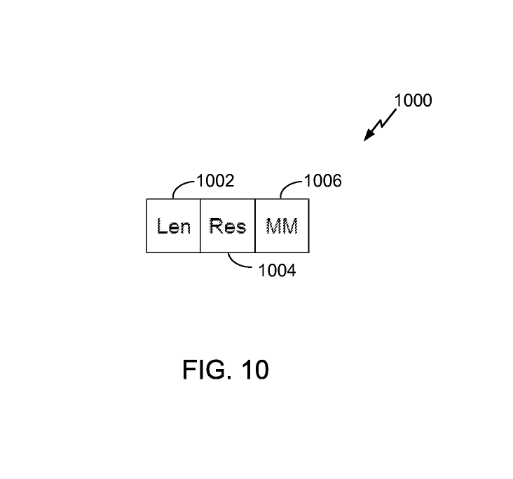

FIG. 10 illustrates an example MSDU subframe header 1000. The MSDU subframe header 1000 may be used similarly to or in place of other subframe headers discussed in this disclosure. The MSDU subframe header 1000 includes a length (Len) field 1002, a reserved (Res) field 1004, and a more MSDU (MM) field 1006. The length field 1002 may have a size of 12 bits, the reserved field may have a size of 3 bits, and the more MSDU field may have a size of 1 bit. The total size of the MSDU subframe header 1000 may be 16 bits or 2 octets.

In some aspects, the MSDU subframe header 1000 may further include a cyclical redundancy check field or a delimiter signature field. The delimiter signature field may be modified in some cases to indicate a difference between two delimiter signature fields.

In some aspects, the length field 1002 may include a short length field or long length field. The short length field may comprise fewer bits of data than the long length field. The short length field may, for instance, be 6 bits long so that a MSDU subframe header 1000 may consist of 1 octet. Such a short length field may allow for 64 octets for a MSDU. On the other hand, the long length field may, for instance, be 12 bits long to allow for a particular maximum size MSDU to be aggregated. The total length of MSDU subframe header 1000 with the long length field may be 2 octets.

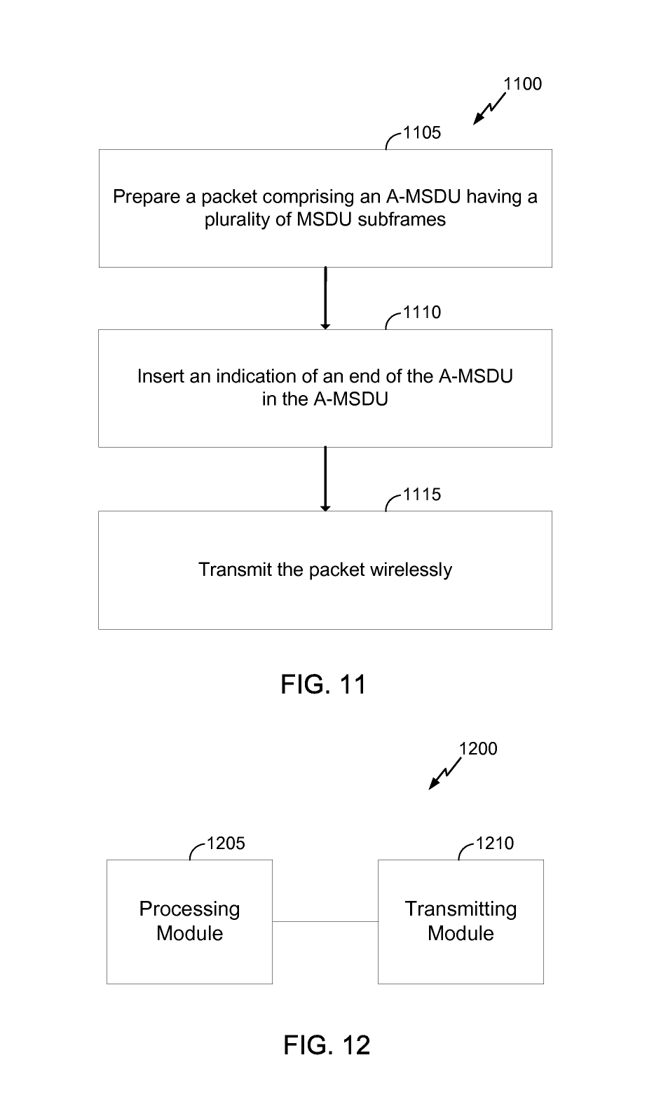

FIG. 11 is a flow chart of an example method 1100 of communicating aggregated packets including delimiters. The method 1100 may be used to communicate a packet, such as the packets discussed in this disclosure. The packet may be generated at either the AP 104 or the STA 106 and transmitted to another node in the wireless network 100. Although the method 1100 is described below with respect to the elements of the wireless device 202t, other components may be used to implement one or more of the steps described herein.

At block 1105, a packet is prepared. The packet comprises an A-MSDU having a plurality of MSDU subframes. Each MSDU subframe comprises a MSDU subframe header and a MSDU. The preparation may be performed by the processor 204 and/or the DSP 220, for example.

At block 1110, an indication of an end of the A-MSDU is inserted in the A-MSDU. The insertion may be performed by the processor 204 and/or the DSP 220, for example.

At block 1115, the packet is wirelessly transmitted. The transmission may be performed by the transmitter 210 of wireless device 202t, for example.

FIG. 12 is a functional block diagram of an example wireless communication device 1200 that may be employed in the wireless communication system of FIG. 1. The wireless communication device 1200 includes a processing module 1205 for preparing a packet comprising an A-MSDU and inserting an indication of an end of the A-MSDU in the A-MSDU. The processing module 1205 may be configured to perform one or more of the functions discussed above with respect to blocks 1105 and 1110 of FIG. 11. The processing module 1205 may correspond to one or more of the processor 204 and/or the DSP 220. The wireless communication device 1200 further includes a transmitting module 1210 for transmitting the packet wirelessly. The transmitting module 1210 may be configured to perform one or more of the functions discussed above with respect to blocks 1115 of FIG. 11. The transmitting module 1210 may correspond to the transmitter 210 of wireless device 202t.

Moreover, in one aspect, means for preparing a packet and means for inserting an indication may comprise the processing module 1205. In another aspect, means for transmitting the packet wirelessly may comprise the transmitting module 1210.

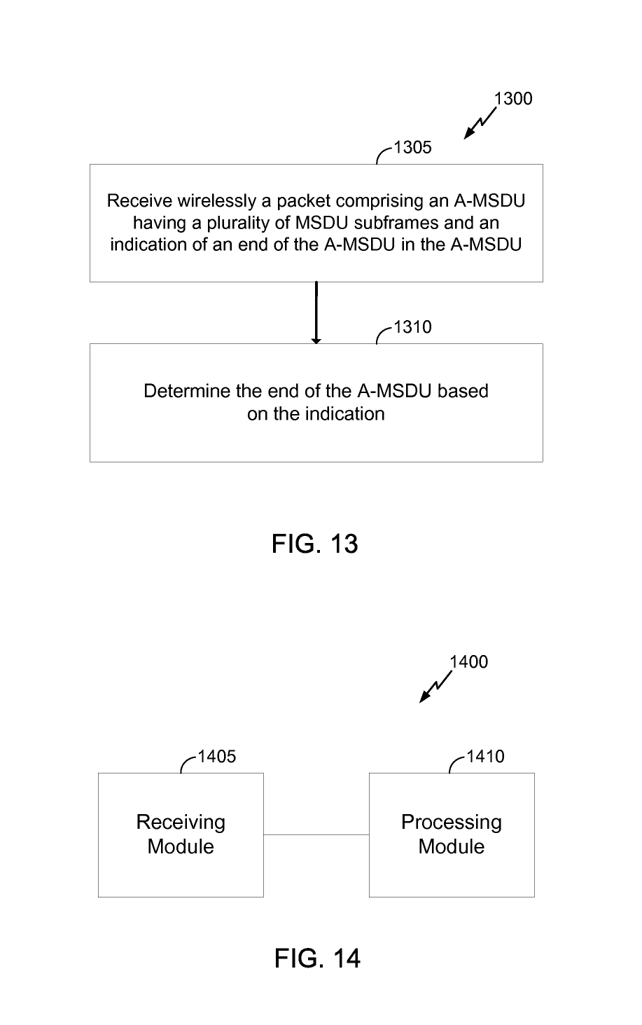

FIG. 13 is a flow chart of an example method 1300 of communicating aggregated packets including delimiters. The method 1300 may be used to communicate a packet, such as the packets discussed in this disclosure. The packet may be generated at either the AP 104 or the STA 106 and transmitted to another node in the wireless network 100. Although the method 1300 is described below with respect to the elements of the wireless device 202r, other components may be used to implement one or more of the steps described herein.

At block 1305, a packet is received wirelessly. The packet comprises an A-MSDU having a plurality of MSDU subframes and an indication of an end of the A-MSDU in the A-MSDU. Each MSDU subframe comprises a MSDU subframe header and a MSDU. The receiving may be performed by the receiver 212 of wireless device 202r, for example.

At block 1310, the end of the A-MSDU is determined based on the indication. The determination may be performed by the processor 204 and/or the DSP 220, for example.

FIG. 14 is a functional block diagram of an example wireless communication device 1400 that may be employed in the wireless communication system of FIG. 1. The wireless communication device 1400 includes a receiving module 1405 for receiving a packet comprising an A-MSDU. The receiving module 1405 may be configured to perform one or more of the functions discussed above with respect to the block 1305 of FIG. 13. The receiving module 1405 may correspond to the receiver 212 of wireless device 202r. The wireless communication device 1400 further includes a processing module 1410 for determining the end of the A-MSDU based on the indication. The processing module 1410 may be configured to perform one or more of the functions discussed above with respect to block 1310 of FIG. 13. The processing module 1205 may correspond to one or more of the processor 204 and/or the DSP 220.

Moreover, in one aspect, means for receiving a packet may comprise the receiving module 1405. In another aspect, means for determining an end of the A-MSDU may comprise the processing module 1410.

What is claimed is:

1. An apparatus for wireless communication comprising:
a processor configured to prepare a packet comprising an aggregated media access control service data unit (A-MSDU) having a plurality of MSDU subframes and to insert an indication of an end of the A-MSDU in the A-MSDU, each MSDU subframe comprising a MSDU subframe header and a MSDU; and
a transmitter configured to transmit the packet wirelessly.

2. The apparatus of claim 1, wherein the indication comprises an indicator MSDU subframe header after the final MSDU subframe of the plurality of MSDU subframes.

3. The apparatus of claim 2, wherein the indicator MSDU subframe header comprises a length field, a value contained in the length field is configured to indicate the end of the A-MSDU.

4. The apparatus of claim 2, wherein the indicator MSDU subframe header comprises a destination address field, a value contained in the destination address field is configured to indicate the end of the A-MSDU.

5. The apparatus of claim 1, wherein the indication comprises an indicator field in one or more MSDU subframe headers of the plurality of MSDU subframes.

6. The apparatus of claim 5, wherein a value contained in the indicator field is configured to indicate a final MSDU subframe of the plurality of MSDU subframes.

7. The apparatus of claim 6, wherein the indicator field comprises a 1 bit field.

8. The apparatus of claim 1, wherein the packet comprises a PLCP protocol data unit (PPDU), the PPDU comprises a PHY header and the A-MSDU.

9. The apparatus of claim 8, wherein no values contained in the PHY header of the PPDU are configured to indicate a length of the A-MSDU.

10. The apparatus of claim 8, wherein the PPDU further comprises an aggregated MAC protocol data unit (A-MPDU) having a plurality of MPDU subframes, each MPDU subframe comprises a MPDU delimiter and a MPDU.

11. The apparatus of claim 10, wherein no values contained in the MPDU delimiter of a first MPDU subframe are configured to indicate a length of the MPDU of the first MPDU subframe.

12. The apparatus of claim 1, wherein the MSDU subframe header comprises a length field, a reserved field, and an indicator field.

13. The apparatus of claim 12, wherein the length field comprises a long length field or a short length field, the short length field comprises fewer bits of data than the long length field.

14. The apparatus of claim 12, wherein the MSDU subframe header further comprises a cyclic redundancy check (CRC) field and a delimiter signature field.

15. The apparatus of claim 14, wherein the delimiter signature field is configured to indicate a difference between two MSDU subframe delimiter signature fields.

16. An apparatus for wireless communication comprising:
a receiver configured to receive wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and
a processor configured to determine the end of the A-MSDU based on the indication.

17. The apparatus of claim 16, wherein the indication comprises an indicator MSDU subframe header after the final MSDU subframe of the plurality of MSDU subframes.

18. The apparatus of claim 17, wherein the indicator MSDU subframe header comprises a length field, a value contained in the length field is configured to indicate the end of the A-MSDU.

19. The apparatus of claim 17, wherein the indicator MSDU subframe header comprises a destination address field, a value contained in the destination address field is configured to indicate the end of the A-MSDU.

20. The apparatus of claim 16, wherein the indication comprises an indicator field in one or more MSDU subframe headers of the plurality of MSDU subframes.

21. The apparatus of claim 20, wherein a value contained in the indicator field is configured to indicate a final MSDU subframe of the plurality of MSDU subframes.

22. The apparatus of claim 21, wherein the indicator field comprises a 1 bit field.

23. The apparatus of claim 16, wherein the packet comprises a PLCP protocol data unit (PPDU), the PPDU comprises a PHY header and the A-MSDU.

24. The apparatus of claim 23, wherein no values contained in the PHY header of the PPDU are configured to indicate a length of the A-MSDU.

25. The apparatus of claim 23, wherein the PPDU further comprises an aggregated MAC protocol data unit (A-MPDU) having a plurality of MPDU subframes, each MPDU subframe comprises a MPDU delimiter and a MPDU.

26. The apparatus of claim 25, wherein no values contained in the MPDU delimiter of a first MPDU subframe are configured to indicate a length of the MPDU of the first MPDU subframe.

27. The apparatus of claim 16, wherein the MSDU subframe header comprises a length field, a reserved field, and an indicator field.

28. The apparatus of claim 27, wherein the length field comprises a long length field or a short length field, the short length field comprises fewer bits of data than the long length field.

29. The apparatus of claim 27, wherein the MSDU subframe header further comprises a cyclic redundancy check (CRC) field and a delimiter signature field.

30. The apparatus of claim 29, wherein the delimiter signature field is configured to indicate a difference between two MSDU subframe delimiter signature fields.

31. A method for wireless communication comprising:
preparing a packet comprising an aggregated media access control service data unit (A-MSDU) having a plurality of MSDU subframes, each MSDU subframe comprising a MSDU subframe header and a MSDU;
inserting an indication of an end of the A-MSDU in the A-MSDU; and
transmitting the packet wirelessly.

32. The apparatus of claim 1, wherein the indication comprises an indicator MSDU subframe header after the final MSDU subframe of the plurality of MSDU subframes.

33. The method of claim 32, wherein the indicator MSDU subframe header comprises a length field, a value contained in the length field is configured to indicate the end of the A-MSDU.

34. The method of claim 32, wherein the indicator MSDU subframe header comprises a destination address field, a value contained in the destination address field is configured to indicate the end of the A-MSDU.

35. The method of claim 31, wherein the indication comprises an indicator field in one or more MSDU subframe headers of the plurality of MSDU subframes.

36. The method of claim 35, wherein a value contained in the indicator field is configured to indicate a final MSDU subframe of the plurality of MSDU subframes.

37. The method of claim 36, wherein the indicator field comprises a 1 bit field.

38. The method of claim 31, wherein the packet comprises a PLCP protocol data unit (PPDU), the PPDU comprises a PHY header and the A-MSDU.

39. The method of claim 38, wherein no values contained in the PHY header of the PPDU are configured to indicate a length of the A-MSDU.

40. The method of claim 38, wherein the PPDU further comprises an aggregated MAC protocol data unit (A-MPDU) having a plurality of MPDU subframes, each MPDU subframe comprises a MPDU delimiter and a MPDU.

41. The method of claim 40, wherein no values contained in the MPDU delimiter of a first MPDU subframe are configured to indicate a length of the MPDU of the first MPDU subframe.

42. The method of claim 31, wherein the MSDU subframe header comprises a length field, a reserved field, and an indicator field.

43. The method of claim 42, wherein the length field comprises a long length field or a short length field, the short length field comprises fewer bits of data than the long length field.

44. The method of claim 42, wherein the MSDU subframe header further comprises a cyclic redundancy check (CRC) field and a delimiter signature field.

45. The method of claim 44, wherein the delimiter signature field is configured to indicate a difference between two MSDU subframe delimiter signature fields.

46. A method for wireless communication comprising:
receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and
determining the end of the A-MSDU based on the indication.

47. The method of claim 46, wherein the indication comprises an indicator MSDU subframe header after the final MSDU subframe of the plurality of MSDU subframes.

48. The method of claim 47, wherein the indicator MSDU subframe header comprises a length field, a value contained in the length field is configured to indicate the end of the A-MSDU.

49. The method of claim 47, wherein the indicator MSDU subframe header comprises a destination address field, a value contained in the destination address field is configured to indicate the end of the A-MSDU.

50. The method of claim 46, wherein the indication comprises an indicator field in one or more MSDU subframe headers of the plurality of MSDU subframes.

51. The method of claim 50, wherein a value contained in the indicator field is configured to indicate a final MSDU subframe of the plurality of MSDU subframes.

52. The method of claim 51, wherein the indicator field comprises a 1 bit field.

53. The method of claim 46, wherein the packet comprises a PLCP protocol data unit (PPDU), the PPDU comprises a PHY header and the A-MSDU.

54. The method of claim 53, wherein no values contained in the PHY header of the PPDU are configured to indicate a length of the A-MSDU.

55. The method of claim 53, wherein the PPDU further comprises an aggregated MAC protocol data unit (A-MPDU) having a plurality of MPDU subframes, each MPDU subframe comprises a MPDU delimiter and a MPDU.

56. The method of claim 55, wherein no values contained in the MPDU delimiter of a first MPDU subframe are configured to indicate a length of the MPDU of the first MPDU subframe.

57. The method of claim 56, wherein the MSDU subframe header comprises a length field, a reserved field, and an indicator field.

58. The method of claim 57, wherein the length field comprises a long length field or a short length field, the short length field comprises fewer bits of data than the long length field.

59. The method of claim 57, wherein the MSDU subframe header further comprises a cyclic redundancy check (CRC) field and a delimiter signature field.

60. The method of claim 59, wherein the delimiter signature field is configured to indicate a difference between two MSDU subframe delimiter signature fields.

61. An apparatus for wireless communication comprising:
means for preparing a packet comprising an aggregated media access control service data unit (A-MSDU) having a plurality of MSDU subframes, each MSDU subframe comprising a MSDU subframe header and a MSDU;
means for inserting an indication of an end of the A-MSDU in the A-MSDU; and
means for transmitting the packet wirelessly.

62. An apparatus for wireless communication comprising:
means for receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and
means for determining the end of the A-MSDU based on the indication.

63. A non-transitory computer storage that stores executable program instructions that direct an apparatus to perform a process that comprises:
preparing a packet comprising an aggregated media access control service data unit (A-MSDU) having a plurality of MSDU subframes, each MSDU subframe comprising a MSDU subframe header and a MSDU;
inserting an indication of an end of the A-MSDU in the A-MSDU; and
transmitting the packet wirelessly.

64. A non-transitory computer storage that stores executable program instructions that direct an apparatus to perform a process that comprises:
receiving wirelessly a packet comprising an aggregated media access control service data unit (A-MSDU) having a plurality of MSDU subframes and an indication of an end of the A-MSDU in the A-MSDU, each MSDU subframe comprising a MSDU subframe header and a MSDU; and
determining the end of the A-MSDU based on the indication.
